(19) United States
(12) Patent Application Publication
(10) Pub. No.: US 2008/0279622 A1
(43) Pub. Date: Nov. 13, 2008

(54) Tension Anchorage System

(75) Inventors: Adil Al-Mayah, Kitchener (CA); Khaled Soudki, Waterloo (CA); Alan Plumtree, Waterloo (CA)

Correspondence Address: OHLANDT, GREELEY, RUGGIERO & PERLE, LLP, ONE LANDMARK SQUARE, 10TH FLOOR, STAMFORD, CT, 06901, US

(73) Assignee: UNIVERSITY OF WATERLOO, Waterloo, ON (CA)

(21) Appl. No.: 10/574,323

(22) PCT Filed: Oct. 3, 2003
(86) PCT No.: PCT/CA2003/001469

§ 371 Date: Jul. 28, 2008

(51) Int. Cl. F16B 2/18; G01N 3/00; F16B 13/04

(52) U.S. Cl. 403/374.1; 73/760; 411/75

(57) ABSTRACT

A wedge anchor comprising a barrel having a wedge receiving face opposite a rod receiving face, a passage extending therethrough between the wedge receiving face and the rod receiving face, the passage narrowing toward the rod receiving face and having an axial cross-sectional profile defining a convex arc; and, a plurality of wedges insertable into the passage, each of the wedges having a respective inner wedge face for defining a rod receiving passage for receiving a rod and an outer wedge face, opposite the inner wedge face, in axial cross-section having a profile complementary to the convex arc.

The present invention relates to an anchorage system for fibre reinforced polymer components.

### BACKGROUND OF THE INVENTION

A pre-stressed, pre-tensioned, or post-tensioned, concrete structure has significantly greater load bearing properties compared to an un-reinforced concrete structure. Steel rods or tendons are used almost universally as the pre-stressing or post-tensioning members. The steel rods and associated anchoring components may become exposed to many corrosive elements, such as de-icing chemicals, salt or brackish water. If this occurs, the rods may corrode, thereby causing the surrounding concrete structure to fracture.

Fibre-reinforced polymer (FRP) rods have been used in place of conventional reinforcing rods. The advantages of using a FRP rod include its light weight relative to steel, resistance to corrosion and its high tensile strength, which in some cases may exceed that of steel. Fibre reinforced polymer rods, however, do not have correspondingly high transverse compressive strength. As a result, traditional clamping or anchor mechanisms used for steel rods crush the rod at its load bearing area, which may lead to premature failure of the FRP tendon at the anchorage point.

Many solutions to this problem have been proposed, but none have resolved this problem satisfactorily. For example, Shrive et al (U.S. Pat. No. 6,082,063) proposes a wedge anchor in which the taper of the wedge is greater than the taper of its receiving bore. This differential tapering results in a higher clamping force being applied away from the rod's loaded area. However, Shrive et al requires very precise pre-seating of the wedge. Thus, its effectiveness is largely dependant on the precision of the pre-seating. Further, the Shrive et al design is not a robust design and it is not tolerant of machining inaccuracies.

There remains a need for a robust and easy to use anchorage system that is able to exploit the high tensile strength and non-corroding properties of carbon fibre reinforced polymer rods.

### SUMMARY OF THE INVENTION

According to the present invention there is provided a wedge anchor comprising a barrel having a wedge receiving face opposite a rod receiving face, a passage extending therethrough between the wedge receiving face and the rod receiving face, the passage narrowing toward the rod receiving face and having an axial cross-sectional profile defining a convex arc; and, a plurality of wedges insertable into the passage, each of the wedges having a respective inner wedge face for defining a rod receiving passage for receiving a rod and an outer wedge face, opposite the inner wedge face, in axial cross-section having a profile complementary to the inner barrel face.

The convex arc may define a radius of curvature.

The wedge anchor may further comprise a sleeve, which is insertable into the rod receiving passage for receiving an end portion of the rod, that may be comprised of a malleable metal, such as copper, aluminium and alloys thereof.

The present invention also provides for a method of testing the tensile strength of a carbon reinforced polymer rod comprising the steps of securing a wedge anchor according to an embodiment of the present invention to a rod end portion; applying a tensile force to the wedge anchor sufficient to break the rod; and, measuring the applied force.

### BRIEF DESCRIPTION OF THE DRAWINGS

These and other features of the preferred embodiments of the invention will become more apparent in the following detailed description in which reference is made to the appended drawings wherein:

FIG. 1 is a schematic cross-sectional view of a wedge anchor according to an embodiment of the present invention;

FIG. 2 is a schematic cross-sectional view of a wedge anchor according to an alternative embodiment of the present invention;

FIG. 3 is a schematic cross-sectional view of a wedge anchor according to a further alternative embodiment of the present invention;

FIG. 4(a) is a plan view of a wedge of a wedge anchor according to an embodiment of the present invention;

FIG. 4(b) is a cross sectional view of a wedge of a wedge anchor according to an embodiment of the present invention;

FIG. 5 is a cross-sectional view of a wedge and barrel portion of a wedge anchor according to an embodiment of the present invention illustrating the relative contact force exerted along the length of the wedge;

FIG. 6(a) is a schematic cross-sectional view of the rod-sleeve-wedge interface of a pre-seated wedge anchor according to an embodiment of the present invention;

FIG. 6(b) is a schematic cross-section view of the rod-sleeve-wedge interface of a secured wedge anchor according to an embodiment of the present invention;

FIG. 7(a) is a schematic cross-sectional view of the rod-layer-wedge interface of a pre-seated wedge anchor according to an embodiment of the present invention;

FIG. 7(b) is a schematic cross-section view of the rod-layer-wedge interface of a secured wedge anchor according to an embodiment of the present invention;

FIG. 8(a) is a cross-sectional view of a cast concrete structural member;

FIG. 8(b) is a cross-sectional view of the cast concrete structural member of FIG. 8(a) illustrating a wedge anchor according an embodiment of the present invention secured to a fibre reinforced polymer rod;

FIG. 8(c) is a cross-sectional view of the cast concrete structural member of FIG. 8(b) illustrating wedge anchors secured to both ends of the fibre reinforced polymer rod; and,

FIG. 9 is a schematic representation of a system for testing the tensile strength of a fibre reinforced polymer rod employing a wedge anchor according to an embodiment of the present invention.

### DESCRIPTION OF THE PREFERRED EMBODIMENTS

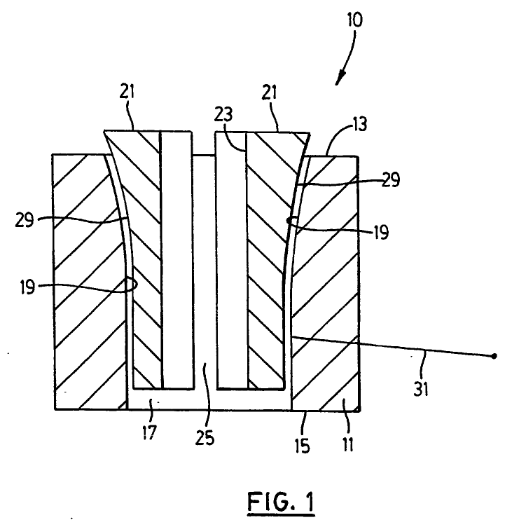

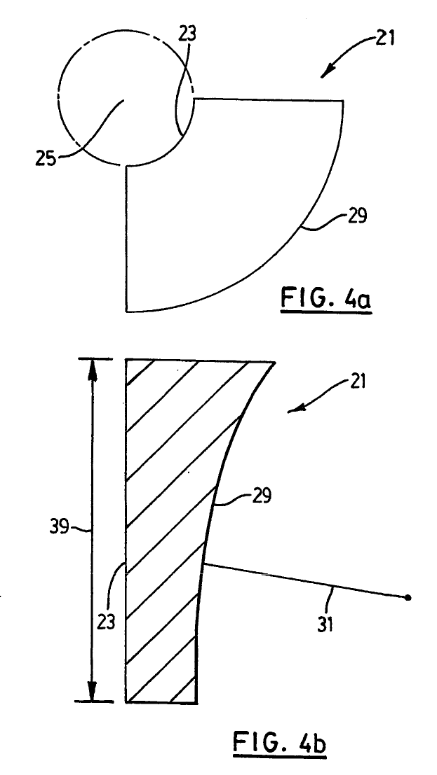

Referring to FIGS. 1 to 4(a) and (b), a wedge anchor 10 according to an embodiment of the present invention is illustrated. The wedge anchor 10 is comprised of a barrel 11 that has a wedge receiving face 13, which is opposite a rod receiving face 15. A passage 17 extends through the barrel 11 between the wedge receiving face 13 and the rod receiving face 15 and narrows toward the rod receiving face 15. In an axial cross-sectional profile, the passage 17 defines a convex arc 19. In a preferred embodiment of the present invention, the axial cross-sectional profile of the convex arc is defined by a radius of curvature 31 described as subtended angle less than 0.5 pi radians. The wedge anchor 10 also includes a plurality of wedges 21, which are insertable into the passage 17. Each of the wedges 21 has a respective inner wedge face 23 for defining a rod receiving passage 25 for receiving a rod 27 and an outer wedge face 29, which is opposite the inner wedge face 23. The outer wedge face 29, in axial cross-section, has a profile complementary to the convex arc 19.

The wedge anchor 10 may include as few as two wedges 21, but generally will employ between 4 and 6 wedges 21. In a preferred embodiment, the wedge anchor 10 is comprised of 4 wedges 21 of equal size.

The wedges 21 have a length 39 selected to ensure that they do not extend beyond the rod receiving face 15 of the barrel 11 when the wedge anchor 10 is in its assembled and secured configuration. In a preferred embodiment, the respective outer wedge faces 29 of wedges 21 have a length 39 less than 0.5 pi radians. In an alternate embodiment, the length of the wedges 21 may extend beyond the rod receiving face of the barrel, provided a cast concrete structural member having a rod receiving entrance is configured to accommodate the extending wedges 21 without hindering the performance of the wedge anchor 10.

The barrel 11 and wedges 21 may be comprised of a hard material, such as a hard metal. In a preferred embodiment, the hard metal is stainless steel. However, any hard material known to those skilled in the art may be employed, such as titanium, copper alloys or ceramic materials. In an alternate embodiment, the barrel 11 and wedges 21 may be comprised of a hard plastic as is known to those skilled in the art.

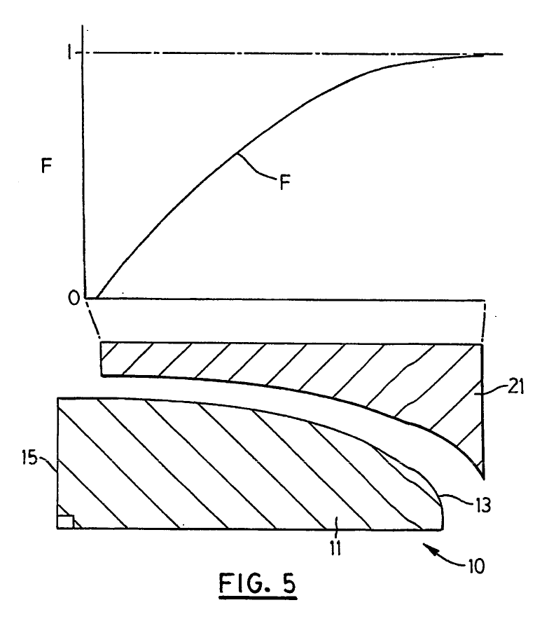

Referring to FIG. 5, a cross-sectional view of a portion of the wedge anchor 10 in its assembled configuration and an accompanying force curve are illustrated. An inward radial or compressive contact force (F) is exerted along the length 39 of the wedge 21 when the wedges 21 are secured in the passage 17. The force curve illustrates the relative inward radial or compressive contact force (F) that is exerted along the length of the wedge 21. Line F illustrates that the compressive force F varies non-linearly over the length of the wedge anchor 10 as a function of the tangent along a surface point of the convex arc 19 and approaches a maximum toward the wedge receiving face 15 of the barrel and a minimum toward the rod receiving face 13 of the barrel 11.

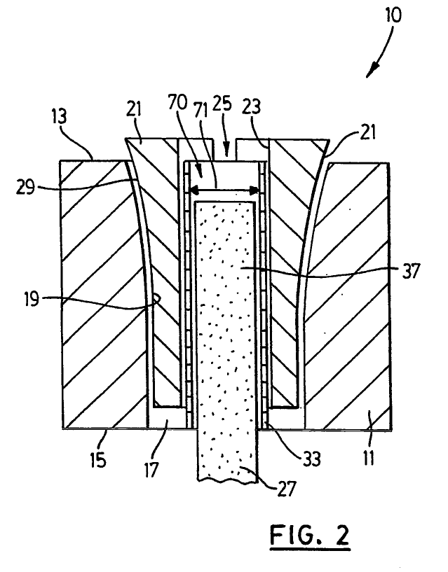

Referring to FIG. 2, a preferred embodiment of the wedge anchor 10 is illustrated, which further includes a sleeve 33, which is insertable into the rod receiving passage 25. The sleeve 33 defines a sleeve passage 70 having an inner sleeve diameter 71 that is configured to receive an end portion 37 of the rod 27. The sleeve 33 may be comprised of a malleable metal. In a preferred embodiment, the malleable metal is cooper or a cooper alloy (e.g. brass or bronze). The sleeve may also be comprised of aluminium, alloys of aluminium, and any other malleable metal known to those skilled in the art.

In an alternate embodiment, the sleeve 33 is comprised of a deformable material having sufficient shear strength to prevent shear stress failure of the sleeve 33 and ensure that the rod 27 is held in place. For example, the sleeve may be comprised of a hard plastic as is known to those skilled in the art.

The sleeve 33 further includes a sleeve inner surface 75, which comes into contact with the rod 27. The sleeve inner surface 75 may be treated with a surface roughening agent (mechanical or chemical), which roughens the sleeve inner surface 75 and thereby enhances the sleeve's 33 ability to hold the rod 27 in place. In a preferred embodiment, the inner surface 75 may be roughened by sandblasting. Any other roughening means known to those skilled in the art may be employed.

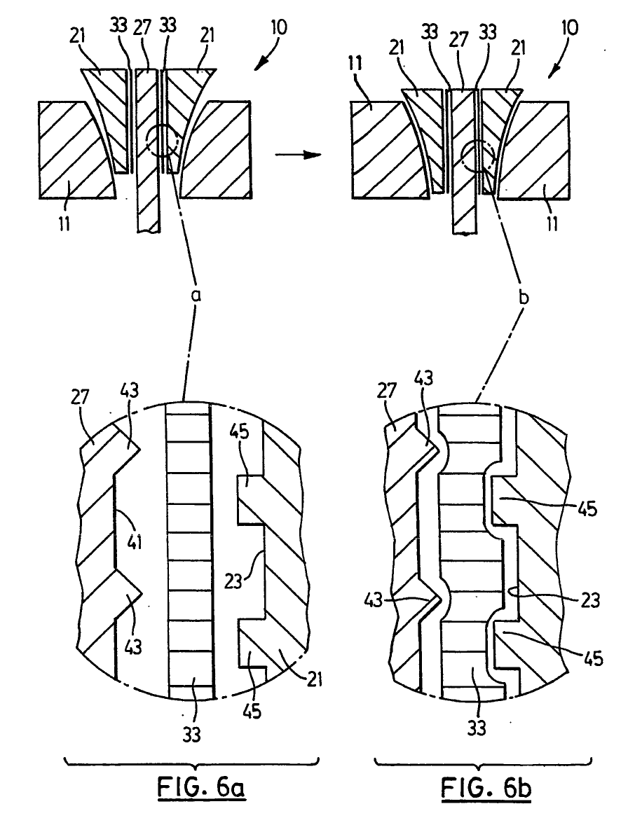

Referring to FIG. 6(a), a wedge anchor 10 and its associated rod 27 are illustrated in their assembled configuration. The interface between rod 27, sleeve 33 and wedge 21 is generally indicated by reference letter A. A magnified view of area A illustrates that rod 27 has an outside surface 41 with surface gaps or irregularities 43. The inner wedge face 23 also has inner wedge face gaps or irregularities 45.

Referring to FIG. 6(b), a wedge anchor 10 and its associated rod 27 are illustrated in a secured configuration. The interface between rod 27, sleeve 33 and wedge 21 is generally indicated by reference letter B. A magnified view of area B illustrates that when the wedges 21 are secured, a radial inward compressive force is applied to the rod 27 via sleeve 33. In effect, the sleeve 33 is squeezed between the rod surface 41 and the inner wedge face 23. This compressive force combined with the gaps and irregularities 43 and 45 causes deformation of the sleeve 33 that corresponds generally to the surface texture of the irregularities 43 and 45, effectively filling any surface gaps or irregularities 43 and 45. Accordingly, the sleeve 33 is selected to be of a thickness to ensure that sufficient sleeve 33 material exists to fill the gaps 43 and 45. In a preferred embodiment, the sleeve thickness is between 0.5 and 0.7 mm (or between 1/15 and 1/20 of the inner diameter 71 of the sleeve 33).

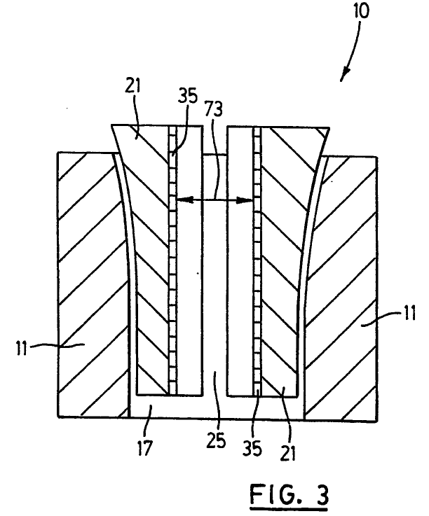

Referring to FIG. 3, an alternate embodiment of a wedge anchor 10 according to the present invention is illustrated, which does not include the sleeve 33. In this embodiment, a layer 35, of the inner wedge face 23 is comprised of a malleable metal. The rod receiving passage 25 has a passage diameter 73. In a preferred embodiment, the malleable metal is copper or a copper alloy (e.g., brass or bronze). The sleeve may also be comprised of aluminium, alloys of aluminium, and any other malleable metal known to those skilled in the art may also be employed.

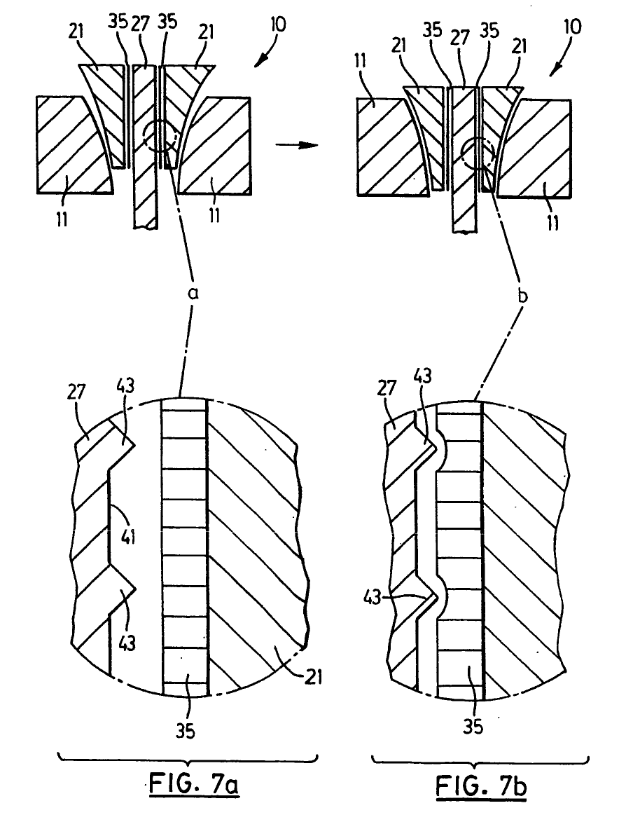

Referring to FIG. 7(a), a wedge anchor 10 and its associated rod 27 are illustrated in their assembled configuration. The interface between rod 27 and wedge 21 is generally indicated by reference letter A. A magnified view of area A illustrates that rod 27 has an outside surface 41 with surface gaps or irregularities 43.

Referring to FIG. 7(b), a wedge anchor 10 and its associated rod 27 are illustrated in a secured configuration. The interface between rod 27 and layer 35 of the wedge 21 is generally indicated by reference letter B. A magnified view of area B illustrates that when the wedges 21 are secured, a radial inward compressive force is applied to the rod 27 via layer 35. In effect, the layer 35 is squeezed between the rod surface 41 and the body of the wedge 21. This compressive force combined with the gaps and irregularities 43 causes deformation of the layer 35 that corresponds generally to the surface texture of the irregularities 43, effectively filling any surface gaps or irregularities 43. Accordingly, the layer 35 is selected to be of a thickness to ensure that sufficient layer 35 material exists to fill the gaps 43. In a preferred embodiment, the layer 35 thickness is between 0.5 and 0.7 mm (or between 1/15 and 1/20 of the passage diameter 73).

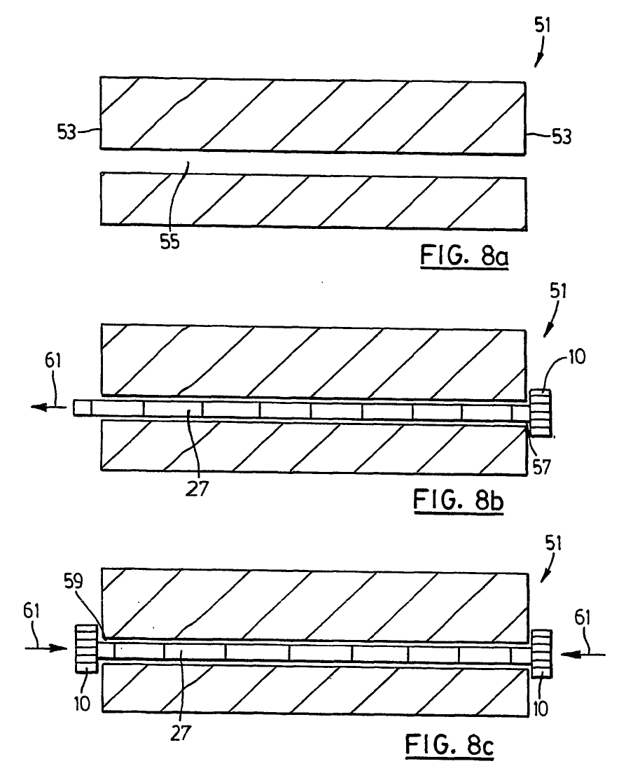

Referring to FIG. 8(a)-(c), a use of the wedge anchor 10 according to an embodiment of the present invention is illustrated. FIG. 8(a) illustrates a cast concrete structural member 51 having respective rod receiving faces 53 at opposite ends of the member 51, with a cavity or passage 55 passing through it between faces 53.

FIG. 8(b) illustrates a fibre reinforced polymer rod 27, such as a carbon reinforced polymer rod, inserted in passage 55 and passing through member 51. A wedge anchor 10 is secured to a first end 57 of the rod 27. Once secured, a tensile force is applied to an opposite end 59 of the rod 27. Once a desired tensile force is applied, a second wedge anchor 10 is secured to the opposite end 59 of the rod 27, thereby maintaining the tension over the length of the rod 27 and resulting in a compressive force, as indicated by force arrows 61, being applied to the member 51 (FIG. 8(c)).

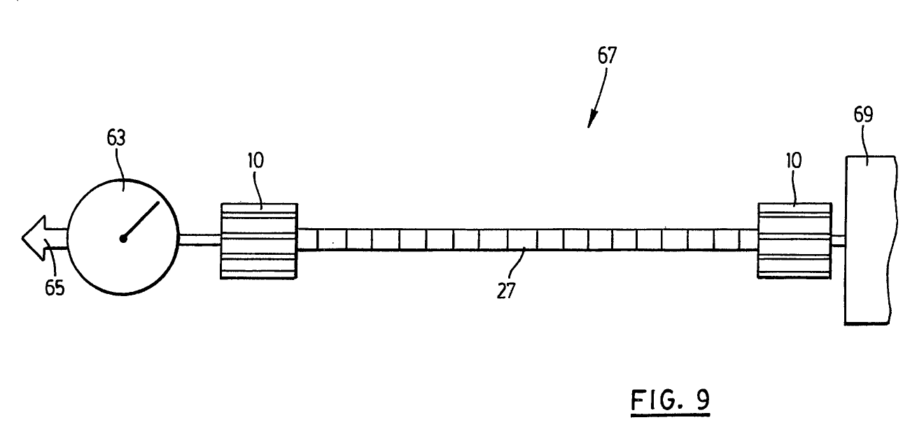

Referring to FIG. 9, a system 67 for testing the tensile strength of a fibre reinforced polymer rod 27 is illustrated. The system 67 comprises a wedge anchor 10, which is secured to a test base 69. The wedge anchor 10 is also secured to one end of the rod 27. At an opposite end of the rod 27, a second wedge anchor 10 is secured. The second wedge anchor 10 is in turn connected to a force measuring unit 63, such that as a tensile force, as indicated by arrow 65, is applied, it is measured by the measuring unit 63. In order to test the tensile strength of a rod 27, the tensile force 65 applied to the system 67 is increased until the force 65 applied exceeds the tensile strength of the rod 27 and the rod 27 breaks. As the force 65 is applied, the measuring unit 63 measures the applied tensile force 65 and as such measures the force 65 applied at the moment the rod 27 breaks.

Although the invention has been described with reference to certain specific embodiments, various modifications thereof will be apparent to those skilled in the art without departing from the spirit and scope of the invention as defined by the claims set out below.

The embodiments of the invention in which an exclusive property or privilege is claimed are defined as follows:

1. A wedge anchor comprising:
a barrel having a wedge receiving face opposite a rod receiving face, a passage extending therethrough between said wedge receiving face and said rod receiving face, said passage narrowing toward said rod receiving face and having an axial cross-sectional profile defining a convex arc; and,
a plurality of wedges insertable into said passage, each of said wedges having a respective inner wedge face for defining a rod receiving passage for receiving a rod and an outer wedge face, opposite said inner wedge face, in axial cross-section having a profile complementary to said convex arc, said wedges not extending beyond the rod receiving face of said barrel when said wedge anchor is in its loaded configuration.

2. The wedge anchor according to claim 1, wherein said convex arc defines a radius of curvature.

3. The wedge anchor according to claims 1 and 2 further comprising a sleeve insertable into said rod receiving passage for receiving an end portion of said rod.

4. The wedge anchor according to claim 3, wherein said wedges stop short of the rod receiving face of said barrel when said wedge anchor is in its loaded configuration.

5. The wedge anchor according to claim 4, wherein the sleeve is comprised of a malleable metal.

6. The wedge anchor according to claim 5 wherein said malleable metal is selected from the group consisting of copper, aluminium and alloys thereof.

7. The wedge anchor according to claim 6, wherein said sleeve has a sleeve thickness of between 0.5 and 0.7 mm.

8. The wedge anchor according to claims 1 and 2, wherein said inner wedge face is comprised of a malleable metal.

9. The wedge anchor according to claim 8, wherein said malleable metal is selected from the group consisting of copper, aluminium, nickel and alloys thereof.

10. The wedge anchor of claim 9, wherein said inner wedge face has a face thickness of between 0.5 and 0.7 mm.

11. The wedge anchor according to claims 1, 2 or 3, wherein said rod receiving passage is comprised of four wedges.

12. The wedge anchor according to claim 11, wherein said four wedges are of equal size.

13. The wedge anchor according to claims 1 and 2, wherein said barrel is comprised of a metal.

14. The wedge anchor according to claim 13, wherein said metal is stainless steel.

15. The wedge anchor according to claims 1 and 2, wherein the arc length is less than 0.5 pi radians.

16. A wedge anchor kit comprising:
a barrel having a wedge receiving face opposite a rod receiving face, a passage extending therethrough between said wedge receiving face and said rod receiving face, said passage narrowing toward said rod receiving face and having an axial cross-sectional profile defining a convex arc; and,
a plurality of wedges for inserting into said passage, each of said wedges having a respective inner wedge face for defining a rod receiving passage for receiving a rod and an outer wedge face, opposite said inner wedge face, in axial cross-section having a profile complementary to said convex arc, said wedges not extending beyond the rod receiving face of said barrel when said wedge anchor is in its loaded configuration.

17. The wedge anchor kit of claim 16 further comprising a sleeve for inserting into said rod receiving passage for receiving an end of said rod.

18. A method of testing the tensile strength of a fibre reinforced polymer rod comprising the steps of:
securing a wedge anchor according to claim 1 to a rod end portion;
applying a tensile force to said wedge anchor sufficient to cause tensile failure of said rod at a point away from said anchor; and,
measuring the applied force.

19. A wedge anchor comprising:
a barrel having a wedge receiving face opposite a rod receiving face, a passage extending therethrough between said wedge receiving face and said rod receiving face, said passage having a convex curved axial cross-sectional profile narrowing toward said rod receiving face; and,
a plurality of wedges insertable into said passage for defining a rod receiving passage for receiving a rod, said plurality of wedges being contoured to slidingly engage with said barrel for exerting a compressive force radially inwardly along the length of the barrel on said rod, said compressive force being at a maximum toward the wedge receiving face of the barrel and at a minimum toward the rod receiving face of the barrel, said wedges not extending beyond the rod receiving ace of said barrel when said wedge anchor is in its loaded configuration.

20. The wedge anchor according to claim 19, wherein the curved axial cross-sectional profile is a convex arc.

21. The wedge anchor according to claim 20, wherein the arc is a radius of curvature.

22. The wedge anchor of claim 21, wherein the arc length is less than 0.5 pi radians.

23. A barrel for use in a wedge anchor comprising a body, said body having a wedge receiving face opposite a rod receiving face, a passage extending therethrough between said wedge receiving face and said rod receiving face, said passage narrowing toward said rod receiving face and having an axial cross-sectional profile defining a convex arc for receiving a plurality of wedges into said passage, each of said wedges having a respective inner wedge face for defining a rod receiving passage for receiving a rod and an outer wedge face, opposite said inner wedge face, in axial cross-section having a profile complementary to said convex arc, said wedges not extending beyond the rod receiving face of said barrel when said wedge anchor is in its loaded configuration.

24. A wedge for use in a wedge anchor having a barrel having a wedge receiving face opposite a rod receiving face, a passage extending therethrough between said wedge receiving face and said rod receiving face, said passage narrowing toward said rod receiving face and having an axial cross-sectional profile defining a convex arc comprising a body, insertable into said passage, said body having an inner wedge face for defining a portion of a rod receiving passage for receiving a rod and an outer wedge face, opposite said inner wedge face, in axial cross-section having a profile defining a concave arc, said wedge not extending beyond the rod receiving face of said barrel when said wedge anchor is in its loaded configuration.

25. A wedge anchor for applying and maintaining a tensile load on a fibre-reinforced polymer rod, said anchor comprising:
a steel barrel having a wedge receiving face opposite a rod receiving face, a passage extruding therethrough between said wedge receiving face and said rod receiving face, said passage narrowing toward said rod receiving face and having an axial cross-sectional profile defining a convex arc having a constant arc radius;
four steel wedges of equal size insertable into said passage, each of said wedges having a respective inner wedge face for defining a rod receiving passage for receiving the rod and an outer wedge face, opposite said inner wedge face, in axial cross-section having a profile complementary to said convex arc defining a concave arc having said constant arc radius, said wedges not extending beyond the rod receiving face of said barrel when said wedge anchor is in its loaded configuration; and,
a sleeve insertable into said rod passage for receiving an end portion of said rod, said sleeve being comprised of a malleable metal, wherein when said anchor is in said loaded configuration, the maximum tensile load applicable is determined by the tensile properties of said fibre-reinforced polymer rod.

26. The wedge anchor according to claim 25, wherein said wedges stop short of the rod receiving face of said barrel when said wedge anchor is in its loaded configuration.

27. A wedge anchor comprising:
a barrel having a wedge receiving face opposite a rod receiving face, a passage extending therethrough between said wedge receiving face and said rod receiving face, said passage narrowing toward said rod receiving face and having an axial cross-sectional profile defining a convex arc having a barrel centre of radius of curvature; and,
a plurality of wedges insertable into said passage, each of said wedges having a respective inner wedge face for defining a rod receiving passage for receiving a rod and an outer wedge face, opposite said inner wedge face, in axial cross section having a profile complementary to said convex arc, said outer wedge face having a wedge-face centre of radius of curvature, which is offset relative to said barrel centre of radius of curvature.
